(19) United States
(12) Patent Application Publication
(10) Pub. No.: US 2003/0218713 A1
(43) Pub. Date: Nov. 27, 2003

(54) Substrate for liquid crystal display device, liquid crystal display device provided with the same,manufacturing method of the same, and manufacturing apparatus of the same

(75) Inventors: Hidehiko Suzuki, Kawasaki (JP); Satoshi Murata, Kawasaki (JP)

Correspondence Address: GREER, BURNS & CRAIN, 300 S WACKER DR, 25TH FLOOR, CHICAGO, IL, 60606, US

(73) Assignee: FUJITSU DISPLAY TECHNOLOGIES CORPORATION

(21) Appl. No.: 10/393,435

(22) Filed: Mar. 20, 2003

(30) Foreign Application Priority Data
Mar. 27, 2002 (JP) 2002-088643
Feb. 18, 2003 (JP) 2003-040231

(51) Int. Cl. G02F 1/1339

(52) U.S. Cl. 349/156

(57) ABSTRACT

The invention relates to a substrate for a liquid crystal display device used for a display part of an information equipment, a liquid crystal display device provided with the same, a manufacturing method of the same, and a manufacturing apparatus of the same, and has an object to provide a substrate for a liquid crystal display device in which a manufacturing process can be simplified and a frame part can be narrowed, a liquid crystal display device provided with the same, a manufacturing method of the same, and a manufacturing apparatus of the same. A liquid crystal display device includes a TFT substrate and a CF substrate disposed to be opposite to each other, a liquid crystal sealed between the two substrates, a light shielding film formed on an outer peripheral part of the CF substrate, a display region defined by the light shielding film, metal layers formed on an outer peripheral part of the TFT substrate at a side of the liquid crystal and having a width of 0.1 mm or less, and a photo-curing sealing agent coated on the outer peripheral part to overlap with the light shielding film when viewed in a vertical direction relative to a substrate surface and provided with a light irradiated region overlapping with the metal layers.

### BACKGROUND OF THE INVENTION

1. Field of the Invention

The present invention relates to a substrate for a liquid crystal display device used for a display part of an information equipment, a liquid crystal display device provided with the same, a manufacturing method of the same, and a manufacturing apparatus of the same.

2. Description of the Related Art

An active matrix type liquid crystal display device including a thin film transistor (TFT) as a switching element in each pixel has attracted attention as the mainstream of a flat panel display, and it is desired to reduce the cost by the improvement of manufacturing yield and the reduction of product defects. An active matrix type color liquid crystal display device is constituted by a TFT substrate on which TFTs and the like are formed, a CF substrate on which color filters (CF) and the like are formed, and a liquid crystal sealed between both the substrates.

In a substrate bonding process of a manufacturing process of a liquid crystal display device, a sealing agent is coated and formed on an outer peripheral part of one of the TFT substrate and the CF substrate. Next, both the substrates are superposed on each other, and a pressure is applied by using a substrate bonding apparatus such as a pressure-heating apparatus or a vacuum heating apparatus to bond them, so that a bonded substrate having a predetermined cell gap is fabricated one by one. Thereafter, in a liquid crystal injection process, a liquid crystal is injected in the cell gap of the bonded substrate by using a vacuum injection method or the like, and a liquid crystal injection port is sealed.

However, as a substrate size is enlarged in recent years, there arises a problem in the vacuum injection method that it is difficult to form the cell gap with high accuracy, and it takes a long time to inject the liquid crystal. As a method for solving the above problem, there is a drop injection method (drop bonding). In the drop injection method, a sealing agent is coated to have a frame shape on an outer peripheral part of one substrate, a predetermined amount of liquid crystal is dropped onto a substrate surface within the frame, and both the substrates are bonded to each other in vacuum to seal the liquid crystal. According to the drop injection method, the bonding of the substrates and the injection of the liquid crystal can be completed almost simultaneously, and the manufacturing process is greatly simplified.

The manufacturing process of a liquid crystal display panel according to the drop injection method will be described in brief. First, a liquid crystal is dropped to plural places on a surface of one substrate by using a liquid crystal drop injection apparatus. Next, the one substrate and the other substrate on which a sealing agent is coated on an outer peripheral part are aligned with each other, and both the substrates are bonded to fabricate a bonded substrate. This process is carried out in vacuum. Next, when the bonded substrate is returned into the air, the liquid crystal in the bonded substrate is diffused by the atmospheric pressure. Next, the sealing agent is cured so that the liquid crystal display panel is completed.

In the drop injection process using the drop injection method, since the bonding of the substrates and the injection of the liquid crystal are performed at the same time, the uncured sealing agent and the liquid crystal come in contact with each other. When an uncured component of the sealing agent is in contact with the liquid crystal for a long time or is exposed to high temperature in that state, the liquid crystal is contaminated. Thus, a thermosetting resin is not generally used as the sealing agent in the case where the drop injection method is used, and a photo-curing resin quickly cured by ultraviolet light (UV light) irradiation is used.

Incidentally, in recent years, as a liquid crystal display panel is enlarged, it is desired to realize frame narrowing, that is, to narrow the width of a frame part outside of a display region. FIG. 11 is a schematic sectional view showing a structural example in the vicinity of a frame part of a conventional liquid crystal display device. As shown in FIG. 11, the liquid crystal display device is constituted by a TFT substrate 102, a CF substrate 104 and a liquid crystal 114 sealed between both the substrates 102 and 104. At the CF substrate 104 of a frame part B outside of a display region A of the liquid crystal display device, a light shielding film (BM) 108 for intercepting the light is formed on a glass substrate 107. Besides, at the side of the TFT substrate 102 of the frame part B, metal wiring lines 110 and 111 such as common storage capacitor lines for bundling plural storage capacitor bus lines are formed on a glass substrate 106.

In FIG. 11, a sealing agent (main seal) 112 is coated at a position where it overlaps with the BM 108 and the metal wiring lines 110 and 111 when viewed in the direction vertical to the substrate surface. However, if the sealing agent 112 is coated at such a position, the light in the vertical direction relative to the substrate surface is intercepted by the BM and is not irradiated to the sealing agent 112. Besides, since a width W of the metal wiring line 111 is very large as compared with a cell gap d, the intensity of the light in an oblique direction relative to the substrate surface is also attenuated by multiple reflection between the BM 108 and the metal wiring line 111, and the light having an intensity necessary for curing is not irradiated to the sealing agent 112. Thus, a poor cured region is produced in the sealing agent 112. Accordingly, in the liquid crystal display device manufactured by using the drop injection method, it is necessary to coat the sealing agent 112 on the outside (the right in the drawing) of the BM 108. Incidentally, with respect to bus lines or the like formed in a direction almost perpendicular to a coating direction of the sealing agent 112, since a wiring interval thereof is wide as compared with a wiring width, they seldom become a problem.

However, when the sealing agent 112 is coated on the outside of the BM 108, there arises a problem that the width of the frame region B becomes large. For example, when the sealing agent 112 can be coated to overlap with the BM 108, the width of the frame region B can be made to substantially coincide with the width of the BM 108. On the other hand, according to the above method, the width of the frame region B becomes wider by the coating width of the sealing agent 112.

Besides, when UV light having a very high intensity is irradiated to the sealing agent to shorten an irradiation time, there arises a problem that leakage light is incident on a liquid crystal 114, and the liquid crystal 114 is contaminated.

### SUMMARY OF THE INVENTION

An object of the invention is to provide a substrate for a liquid crystal display device in which a manufacturing process can be simplified and a frame part can be narrowed, a liquid crystal display device provided with the same, a manufacturing method of the same, and a manufacturing apparatus of the same.

The above object is achieved by a liquid crystal display device characterized by comprising two substrates disposed to be opposite to each other, a liquid crystal sealed between the two substrates, a light shielding film formed on an outer peripheral part of one of the substrates to intercept light, a display region defined by the light shielding film, a metal layer formed on the other substrate at a side of the liquid crystal of the outer peripheral part and having a width of 0.1 mm or less, and a photo-curing sealing agent coated on the outer peripheral part to overlap with the light shielding film when viewed in a vertical direction relative to a substrate surface and provided with a light irradiated region overlapping with the metal layer.

### BRIEF DESCRIPTION OF THE DRAWINGS

FIG. 1 is a view showing a structure of a liquid crystal display device according to a first embodiment of the invention;

FIG. 2 is a view showing a structure of the liquid crystal display device according to the first embodiment of the invention;

FIG. 3 is a sectional view showing a structure of the liquid crystal display device according to the first embodiment of the invention;

FIG. 4 is a view showing a structure of a manufacturing apparatus of the liquid crystal display device according to the first embodiment of the invention;

FIG. 5 is a sectional view showing a liquid crystal display device according to a second embodiment of the invention;

FIG. 6 is a sectional view showing a liquid crystal display device according to a third embodiment of the invention;

FIG. 7 is a view showing a manufacturing process of a liquid crystal display device according to a fourth embodiment of the invention;

FIG. 8 is a sectional view showing a structure of a substrate for a liquid crystal display device according to the fourth embodiment of the invention;

FIG. 9 is a sectional view showing a structure of a substrate for a liquid crystal display device according to a fifth embodiment of the invention;

FIG. 10 is a sectional view showing a modified example of the structure of the substrate for the liquid crystal display device according to the fifth embodiment of the invention; and

FIG. 11 is a sectional view showing a structural example of a conventional liquid crystal display device.

### DETAILED DESCRIPTION OF THE PREFERRED EMBODIMENTS

(First Embodiment)

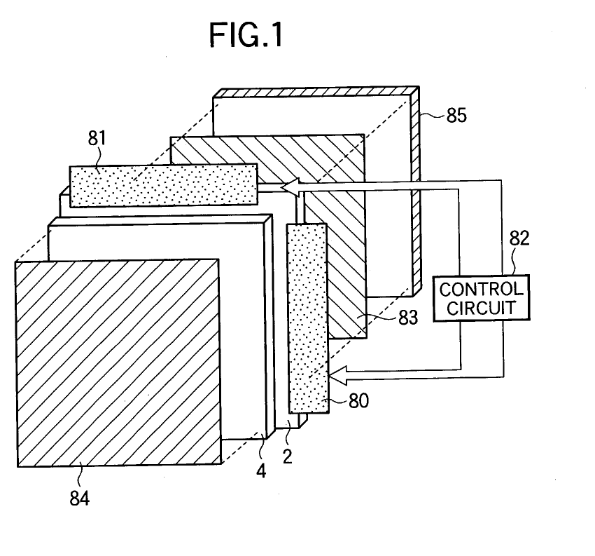

A liquid crystal display device according to a first embodiment and a manufacturing apparatus of the same will be described with reference to FIGS. 1 to 4. FIG. 1 shows a schematic structure of the liquid crystal display device according to this embodiment. The liquid crystal display device has such a structure that a TFT substrate 2 on which TFTs and the like are formed is made to be opposite to and to be bonded to a CF substrate 4 on which CFs and the like are formed, and a liquid crystal is sealed between both the substrates 2 and 4. On the TFT substrate 2, gate bus lines and storage capacitor bus lines and drain bus lines are formed to intersect with each other through an insulating film.

The TFT substrate 2 is provided with a gate bus line driving circuit 80 on which a driver IC for driving the plural gate bus lines is mounted and a drain bus line driving circuit 81 on which a driver IC for driving the plural drain bus lines is mounted. These driving circuits 80 and 81 output a scanning signal or a data signal to a predetermined gate bus line or drain bus line on the basis of a predetermined signal outputted from a control circuit 82. A polarizing plate 83 is disposed on a substrate surface of the TFT substrate 2 opposite to an element formation surface, and a back light unit 85 is attached to a reverse surface of the polarizing plate 83 with respect to the TFT substrate 2. On the other hand, a polarizing plate 84 disposed in crossed Nicols is bonded to a surface of the CF substrate 4 opposite to a CF formation surface.

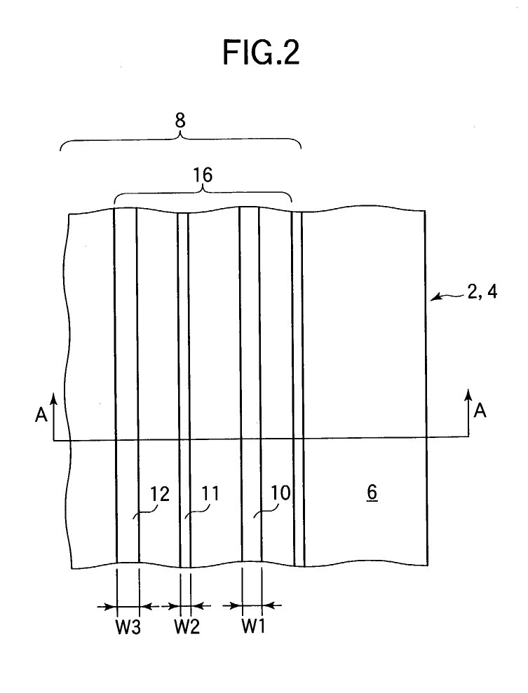

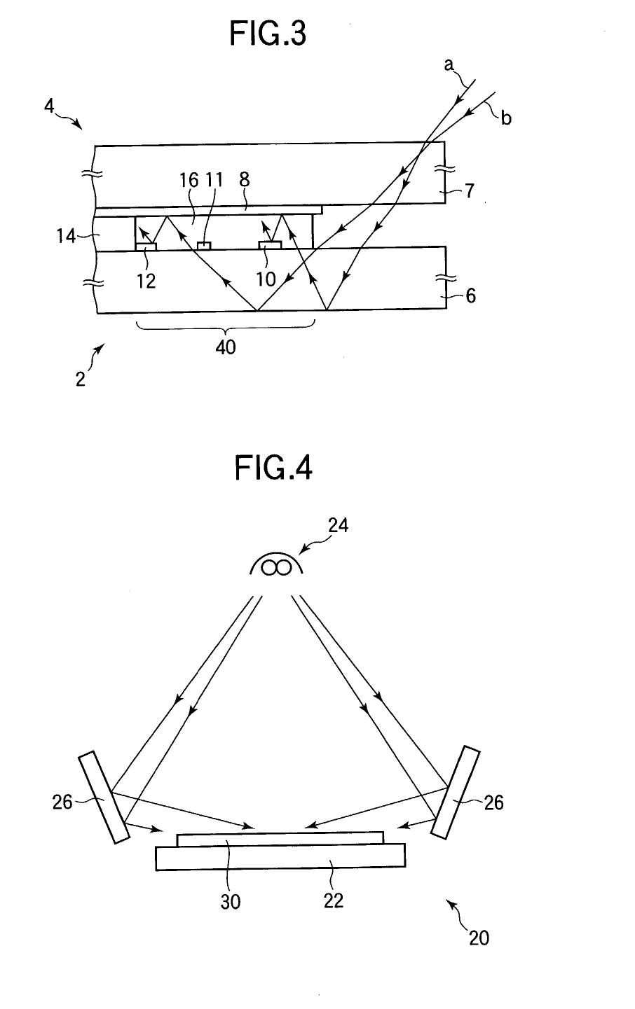

FIG. 2 shows a structure in the vicinity of a frame part of the liquid crystal display device according to this embodiment viewed from the side of the TFT substrate 2. FIG. 3 is a schematic sectional view in the vicinity of the frame part of the liquid crystal display device taken along line A-A of FIG. 2. As shown in FIGS. 2 and 3, the TFT substrate 2 and the CF substrate 4 are bonded to each other through a photo-curing sealing agent 16 coated on an outer peripheral part of one of the substrates 2 and 4.

At the side of the CF substrate 4, a BM 8 for intercepting the light is formed on a transparent glass substrate 7. Besides, at the side of the TFT substrate 2, metal wiring lines 10, 11 and 12 such as, for example, common storage capacitor lines for bundling plural storage capacitor bus lines (not shown) are formed on a transparent glass substrate 6. The metal wiring lines 10, 11 and 12 are formed, for example, in parallel with a coating direction of the sealing agent 16. A width W1 of the metal wiring line 10, a width W2 of the metal wiring line 11 and a width W3 of the metal wiring line 12 are all 0.1 mm or less.

When the widths of the metal wiring lines 10, 11 and 12 are made 0.1 mm or less, it has been found from experiments that light of multiple reflection between the BM 8 and the metal wiring lines 10, 11 and 12 can be irradiated to regions of the sealing agent 16 where it overlaps with the metal wiring lines 10, 11 and 12.

Although described later in detail, according to this structure, light beams a and b obliquely incident on a substrate surface are reflected at a rear surface of the glass substrate 6 and the metal wiring lines 10, 11 and 12, so that the light having an intensity necessary for photo-curing is irradiated to the whole region of the sealing agent 16. Hereinafter, a sealing agent region to which the light having the intensity necessary for photo-curing is irradiated is called a light irradiated region. In this embodiment, as described above and as shown in FIG. 3, the light irradiated region 40 is the whole region of the sealing agent 16.

Next, a manufacturing method of the liquid crystal display device according to this embodiment will be described. First, the TFT substrate 2 and the CF substrate 4 are manufactured in respective processes. Next, for example, a predetermined amount of liquid crystal is dropped onto plural places of a surface of the TFT substrate 2, and the sealing agent 16 is coated on the outer peripheral part of the CF substrate 4. Next, both the substrates 2 and 4 are aligned with each other and are bonded in vacuum by using a substrate bonding apparatus to fabricate a bonded substrate. Next, when the bonded substrate is returned into the air, the liquid crystal in the bonded substrate is diffused by the atmospheric pressure.

Next, UV light is irradiated to the sealing agent 16 by using a UV light irradiation apparatus. As shown in FIG. 3, the light beams a and b incident on the glass substrate 7 in an inclined direction relative to the substrate surface are transmitted through the glass substrate 7 and are incident on the glass substrate 6. The light beams a and b are reflected at the rear surface (lower part in the drawing) of the glass substrate 6 or a surface of an irradiation stage (not shown in FIG. 3) being in contact with the rear surface of the glass substrate 6, and are incident on the sealing agent 16. Thereafter, the light beams a and b are further reflected at surfaces of the metal wiring lines 10, 11 and 12, and are also incident on regions of the sealing agent 16 where the metal wiring lines 10, 11 and 12 are formed to overlap. By this, the UV light is irradiated on all the regions of the sealing agent 16, and the sealing agent 16 is quickly cured. The liquid crystal display device is completed through the above processes.

Next, a manufacturing apparatus of the liquid crystal display device according to this embodiment will be described with reference to FIG. 4. FIG. 4 shows a schematic structure of a UV light irradiation apparatus 20 used for the manufacture of the liquid crystal display device according to this embodiment. As shown in FIG. 4, the UV light irradiation apparatus 20 includes an irradiation stage 22 for mounting thereon a bonded substrate 30 in which a liquid crystal 14 is injected by using a drop injection method and the photo-curing sealing agent 16 is coated on the outer peripheral part. A UV light source 24 for irradiating UV light is disposed above the irradiation stage 22. Besides, at sides of the irradiation stage 22, reflection mirrors 26 are disposed which reflect the UV light from the UV light source 24 so that the light is incident on the surface of the bonded substrate 30 in an inclined direction. The reflection mirrors 26 are provided, for example, at four sides of the irradiation stage 22, respectively.

In the UV light irradiation apparatus 20, the UV light not irradiated to the bonded substrate 30 can be reflected by the reflection mirrors 26 in the direction toward the bonded substrate 30. Thus, the use efficiency of the UV light is improved. Besides, an incident angle of the UV light incident on the bonded substrate 30 becomes large, so that a component of the UV light in a substrate surface direction is increased, and therefore, the number of times of reflection of the UV light is decreased.

The irradiation stage 22 includes, for example, a metal layer having a high optical reflectance or a white plate on the surface (irradiated surface). By this, the light from the UV light source 24 can be efficiently irradiated to the sealing agent 16. The irradiation stage 22 may include thereon a scattering sheet for scattering and reflecting the light.

As stated above, according to this embodiment, even when the photo-curing sealing agent 16 is coated to overlap with the BM 8, the sealing agent 16 can be cured. Thus, even if the drop injection method is used for the manufacture, it is possible to realize the liquid crystal display device in which the frame part can be narrowed.

(Second Embodiment)

Next, a liquid crystal display device according to a second embodiment of the invention will be described with reference to FIG. 5. FIG. 5 shows a schematic sectional structure in the vicinity of a frame part of the liquid crystal display device according to this embodiment. As shown in FIG. 5, metal wiring lines 41 and 42 are formed on a glass substrate 6 of a TFT substrate 2 substantially in parallel with a coating direction of a sealing agent 16, for example. The width of the metal wiring line 41 formed outside is larger than 0.1 mm and the width of the metal wiring line 42 formed inside is 0.1 mm or less.

As described in the first embodiment, when the width of the metal wiring line is 0.1 mm or less, light by multiple reflection between the BM and the metal wiring line can be irradiated to a sealing agent region overlapping with the metal wiring line. On the other hand, when the width of the metal wiring line exceeds 0.1 mm, there is a possibility that light necessary for curing can not be irradiated to a sealing agent region on the metal wiring line. Accordingly, in the sealing agent 16 according to this embodiment, a light irradiated region 40 is positioned in an end part at the side of a liquid crystal 14.

Next, a manufacturing method of the liquid crystal display device according to this embodiment will be described. Similarly to the first embodiment, a bonded substrate 30 is mounted on the irradiation stage 22 of the UV light irradiation apparatus 20 and UV light is irradiated. As shown in FIG. 5, light beams c and d incident on the glass substrate 7 in an inclined direction relative to the substrate surface are transmitted through the glass substrate 7 and are incident on the glass substrate 6. The light beam c is reflected at the rear surface of the glass substrate 6 or the surface of the irradiation stage 22 and is incident on the light irradiated region 40 of the sealing agent 16. Besides, the light beam d is reflected at the rear surface of the glass substrate 6 or the surface of the irradiation stage 22, and is further reflected at the rear surface of the metal wiring line 41. The light beam d is again reflected at the rear surface of the glass substrate 6 or the surface of the irradiation stage 22, and is incident on the light irradiated region 40 of the sealing agent 16. The light beam d is further reflected at the BM 8 and the metal wiring line 42, and is also incident on a region of the light irradiated region 40 of the sealing agent 16 where the metal wiring line 42 is formed to overlap.

The thickness of the glass substrate 6 is very large as compared with a cell gap. Thus, the number of times of reflection until the UV light reaches the light irradiated region 40 of the sealing agent 16 is relatively small, and the attenuation of intensity of the UV light is small. By this, the UV light having an intensity necessary for curing is irradiated to the whole light irradiated region 40 of the sealing agent 16, and the light irradiated region 40 of the sealing agent 16 is quickly cured. Thus, liquid crystal contamination does not occur.

Incidentally, since the sealing agent 16 in a region where it is formed to overlap with the metal wiring line 41 is hardly cured, there is a case where the adhesion strength between both the substrates 2 and 4 is not sufficient. In this case, a thermosetting sealing agent is previously mixed, and for example, secondary curing may be performed in which the bonded substrate 30 is heated to cure the uncured sealing agent 16.

Besides, if the width of the light irradiated region 40 is extremely small, the light leaks toward the side of the liquid crystal, and liquid crystal contamination occurs. Thus, it is necessary to determine the width of the light irradiated region 40 by mutual relation among material property values, various conditions of the manufacturing process and the like.

(Third Embodiment)

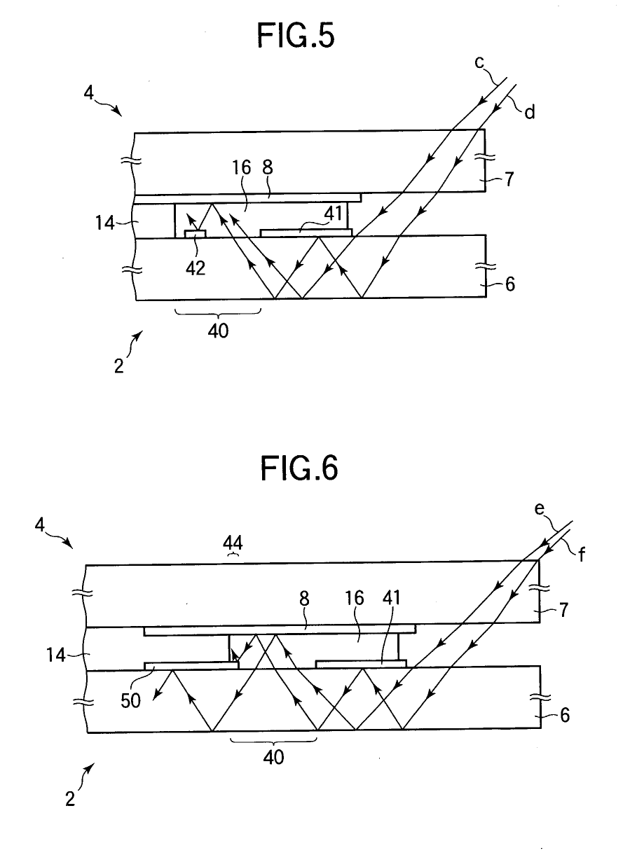

Next, a liquid crystal display device according to a third embodiment of the invention will be described with reference to FIG. 6. FIG. 6 shows a schematic sectional structure in the vicinity of a frame part of the liquid crystal display device according to this embodiment. As shown in FIG. 6, on a glass substrate 6 of a TFT substrate 2, a light shielding layer 50 made of a metal layer such as, for example, a gate bus line formation layer or a drain bus line formation layer is formed within a range from an end part of a sealing agent 16 at a side of a liquid crystal 14 to an outside of a display region. The light shielding layer 50 is provided to prevent contamination of the liquid crystal 14 due to UV light transmitted through the sealing agent 16 and incident on the liquid crystal 14. The light shielding layer 50 includes an overlap region 44 overlapping with the sealing agent 16 and having an overlap width of 0.1 mm or less when viewed in a vertical direction relative to a substrate surface.

As shown in FIG. 6, light beams e and f incident on a glass substrate 7 in an inclined direction relative to the substrate surface are transmitted through the glass substrate 7 and are incident on the glass substrate 6. The light beam e is reflected at the rear surface of the glass substrate 6 or the surface of the irradiation stage 22, and is further reflected at the surface of a BM 8. The light beam e is again reflected at the rear surface of the glass substrate 6 or the surface of the irradiation stage 22 and advances to the liquid crystal 14 of the frame part. However, the light beam is reflected at the light shielding layer 50. As stated above, the light shielding layer 50 increases the number of times of reflection of the UV light, and attenuates the intensity of the UV light to the utmost.

The light beam f incident on the glass substrate 6 is reflected at the rear surface of the glass substrate 6 or the surface of the irradiation stage 22, and is further reflected at the rear surface of the metal wiring line 41. The light beam f is again reflected at the rear surface of the glass substrate 6 or the surface of the irradiation stage 22, and is reflected at the surface of the BM 8. Thereafter, the light beam is subjected to multiple reflection between the surface of the light shielding layer 50 and the surface of the BM 8, and the intensity is attenuated. Thus, when the UV light is incident on the liquid crystal 14, the intensity is sufficiently lowered.

According to this embodiment, since the UV light having a high intensity is not incident on the liquid crystal 14, the liquid crystal 14 is not contaminated. Thus, the liquid crystal display device having excellent display quality can be obtained.

(Fourth Embodiment)

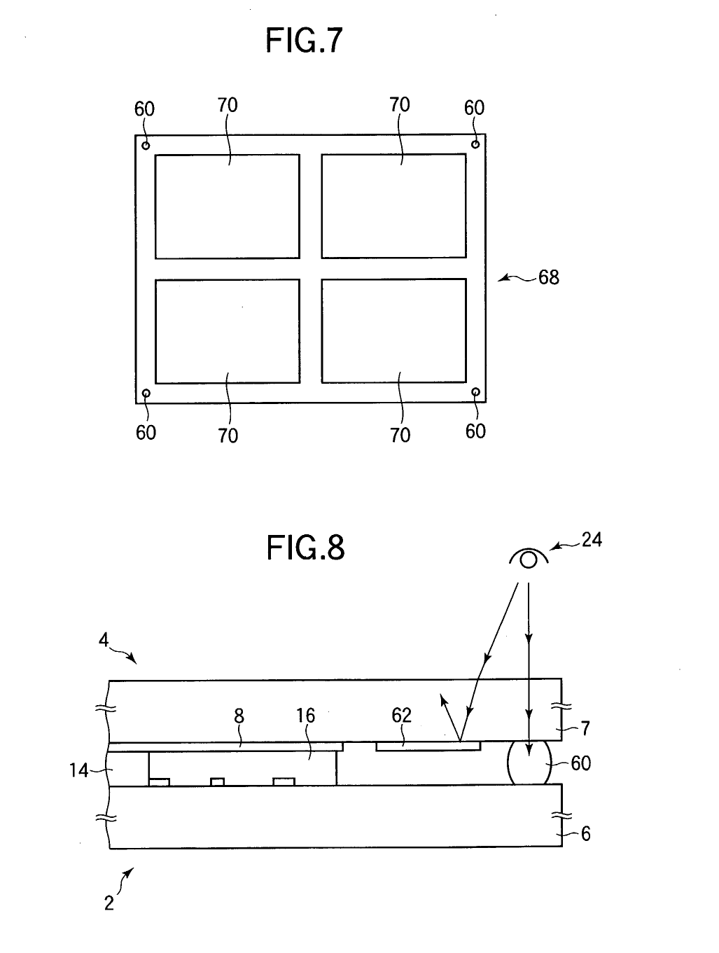

Next, a substrate for a liquid crystal display device according to a fourth embodiment and a liquid crystal display device provided with the same will be described with reference to FIGS. 7 and 8. First, a manufacturing process of a liquid crystal display device as the premise of this embodiment will be described. FIG. 7 is a view for explaining the manufacturing process of the liquid crystal display device according to this embodiment, and shows a multiple (for example, four-face) bonded substrate 68. The bonded substrate 68 is constructed such that for example, a TFT substrate 2 on which a liquid crystal 14 is dropped is bonded to a CF substrate 4 in which a sealing agent 16 is coated on an outer peripheral part of each liquid crystal display panel 70. Besides, temporary fastening sealing agents 60 each having, for example, a circular shape with a diameter of 1 to 2 mm are coated on, for example, four corners of the bonded substrate 68.

Alignment of the TFT substrate 2 and the CF substrate 4 is performed with predetermined bonding accuracy by using a substrate bonding apparatus, and immediately after that, the temporary fastening sealing agents 60 are locally irradiated with the UV light and are cured. The temporary fastening sealing agents 60 are cured to have such strength that for example, when it is transported from the substrate bonding apparatus to a UV light irradiation apparatus, a position shift does not occur between both the substrates 2 and 4. However, at this time of point, since the accuracy of a cell gap and the diffusion of the liquid crystal 14 are insufficient, if the sealing agent (main seal) 16 is also cured, product defects are produced.

FIG. 8 is a sectional view showing a schematic structure of the substrate for the liquid crystal display device according to this embodiment. As shown in FIG. 8, the CF substrate 4 includes a light shielding layer 62 made of, for example, a metal layer in the vicinity of a temporary fastening sealing agent coating region where the temporary fastening sealing agent 60 is coated. The light shielding layer 62 intercepts the light so that leakage light of UV light irradiated to the temporary fastening sealing agent 60 from a UV light source 24 is not irradiated to the sealing agent 16.

Incidentally, the temporary fastening sealing agent 60 and the light shielding layer 62 may be cut off and discarded in a process before the liquid crystal display device is completed.

According to this embodiment, when the temporary fastening sealing agents 60 are cured, the sealing agent 16 is not cured, and therefore, product defects of the liquid crystal display device are decreased.

(Fifth Embodiment)

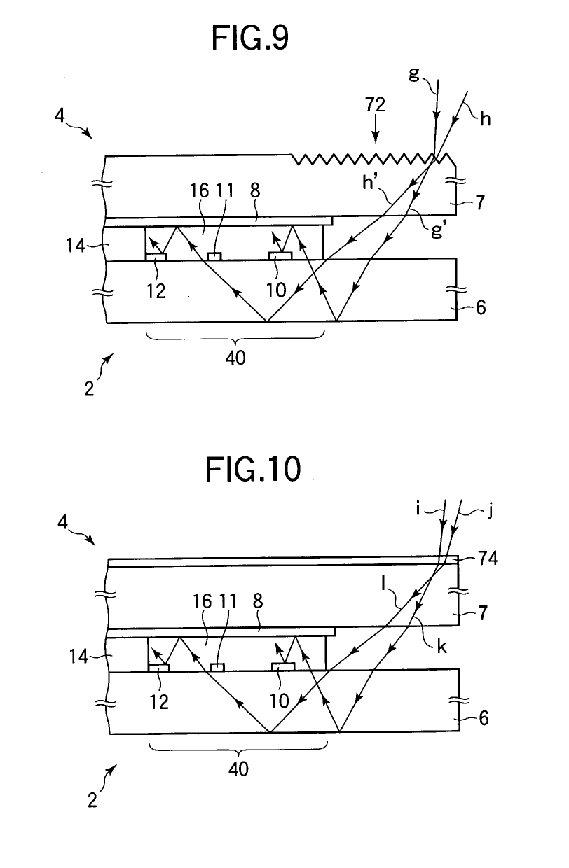

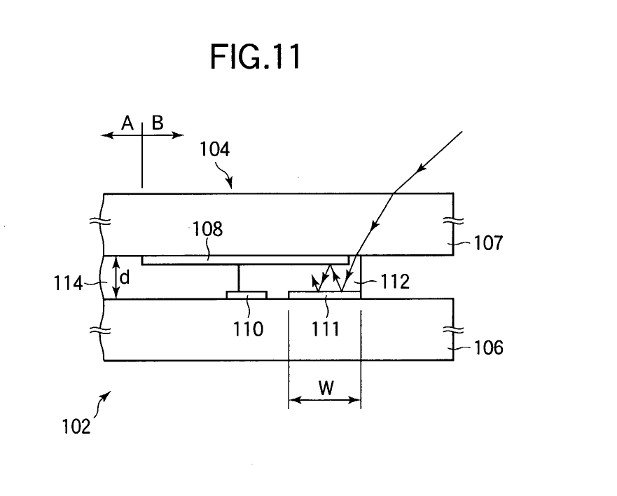

Next, a liquid crystal display device according to a fifth embodiment of the invention and a manufacturing method of the same will be described with reference to FIGS. 9 and 10. FIG. 9 is a sectional view schematically showing a structure in the vicinity of a frame part of the liquid crystal display device according to this embodiment. As shown in FIG. 9, on a surface of a glass substrate 7 of a CF substrate 4 at the outside of a panel (upper part in the drawing), for example, embossed minute irregularities 72 are formed as a light path changing part for changing a light path. The irregularities 72 are formed at least in a region outside of a BM 8. Besides, the irregularities 72 are formed before a step of curing a sealing agent 16 by irradiation of UV light to fabricate a bonded substrate.

Next, a manufacturing method of the liquid crystal display device according to this embodiment will be described. First, a TFT substrate 2 and a CF substrate 4 are manufactured by a predetermined process. Next, a light path changing treatment is performed in which for example, the embossed minute irregularities 72 are formed at a rear surface side of the CF substrate 4 with respect to a formation surface with the BM 8 and at at least a part outside of the BM 8. Next, a predetermined amount of liquid crystal 14 is dropped onto, for example, plural places of a surface of the TFT substrate 2, and a sealing agent 16 is coated on an outer peripheral part of the CF substrate 4. Next, both the substrates 2 and 4 are aligned and bonded to each other in vacuum by using a substrate bonding apparatus, so that a bonded substrate is fabricated. Next, when the bonded substrate is returned into the air, the liquid crystal 14 in the bonded substrate is diffused by the atmospheric pressure. Incidentally, the irregularities 72 may be formed at other timings before a step of curing the sealing agent 16 by irradiation of UV light described later, for example, it may be formed before CFs are formed on the glass substrate 7 or after the bonded substrate is fabricated.

Next, the UV light is irradiated to the sealing agent 16 by using a UV light irradiation apparatus. As shown in FIG. 9, light beams g and h incident on the glass substrate 7 in a direction relatively close to a vertical direction relative to a substrate surface after formation of the irregularities 72 (hereinafter simply referred to as “substrate surface”) are incident on one inclined surface of the irregularities 72. The light beam g incident on the inclined surface inclined so that the outside (the right in the drawing) of the glass substrate 7 becomes low is refracted into a light beam g′. Similarly, the light beam h incident on the inclined surface inclined so that the outside of the glass substrate 7 becomes low is refracted into a light beam h′. The light path of the light beam g′ is changed toward the side of the sealing agent 16 with respect to the light beam g, and the light path of the light beam h′ is changed toward the side of the sealing agent 16 with respect to the light beam h. The light beams g′ and h′ have light paths changed in directions closer to a direction parallel to the substrate surface.

The light beams g′ and h′ are transmitted through the glass substrate 7 and are incident on the glass substrate 6. The light beams g′ and h′ are reflected at the rear surface (panel outside surface) of the glass substrate 6 or the surface of an irradiation stage (not shown in FIG. 9) being in contact with the rear surface of the glass substrate 6, and are incident on the sealing agent 16. Thereafter, the light beams g′ and h′ are further reflected at the surfaces of the metal wiring lines 10, 11 and 12, and are also incident on regions of the sealing agent 16 where the metal wiring lines 10, 11 and 12 are formed to overlap. By this, the UV light is irradiated on all the regions of the sealing agent 16, and the sealing agent 16 is quickly cured. Thereafter, part of the substrates 2 and 4 outside the sealing agent 16 may be cut of f and discarded. The liquid crystal display device according to this embodiment is completed through the above processes.

In this embodiment, although the irregularities 72 are formed to have the embossed shape, the irregularities 72 may be formed to have a prism shape for changing the light path of light incident on the glass substrate 7 toward the side of the sealing agent 16. Besides, in addition to that, the irregularities 72 may be formed to have another shape as long as a light path of at least a part of light can be changed toward the side of the sealing agent 16 by scattering or refracting the incident light. Further, in this embodiment, although the irregularities 72 are formed on the panel outside surface of the CF substrate 4, the irregularities 72 may be formed on the panel outside surface (the lower part in the drawing) of the TFT substrate 2.

Besides, if the irregularities 72 are so minute that the display quality does not deteriorate, they may be formed in a display region. If the minute irregularities 72 are formed in the whole display region of the panel outside surface of the CF substrate 4, they serve as a diffusion sheet for preventing surface reflection, and therefore, there is also an effect that bonding of the diffusion sheet onto the surface of the glass substrate 7 becomes unnecessary.

According to this embodiment, the light path of light incident on the glass substrate 7 in a direction relatively close to the vertical direction relative to the substrate surface can be changed toward the side of the sealing agent 16. In general, when light is irradiated by using a UV irradiation apparatus, since luminous energy of the light incident on the glass substrate 7 in the direction relatively close to the vertical direction relative to the substrate surface is large, it becomes possible to irradiate the sealing agent 16 with the light having more luminous energy. Accordingly, even if the photo-curing sealing agent 16 is coated to overlap with the BM 8, the sealing agent 16 can be more quickly cured. Thus, even if the drop injection method is used for manufacture, it is possible to realize the liquid crystal display device in which the frame part can be narrowed.

Next, a modified example of the liquid crystal display device according to this embodiment and the manufacturing method of the same will be described. FIG. 10 shows a structure of a liquid crystal display device according to this modified example. As shown in FIG. 10, a diffusion sheet 74 of an optical film is bonded, as a light path changing part for changing the light path of light, to a surface of a glass substrate 7 of a CF substrate 4 at the panel outside (the upper part in the drawing). The diffusion sheet 74 is bonded to at least a region outside a BM 8. Besides, the diffusion sheet 74 is bonded before a step of curing a sealing agent 16 by irradiation of UV light to fabricate a bonded substrate.

Next, a manufacturing method of the liquid crystal display device according to this modified example will be described. First, a TFT substrate 2 and a CF substrate 4 are manufactured by a predetermined process. Next, a light path changing treatment is performed in which the diffusion sheet 74, which is generally bonded after a bonded substrate is fabricated, is bonded to substantially the whole surface (at least a part outside the BM 8) of the rear surface side of the CF substrate 4 with respect to the formation surface with the BM 8. Next, for example, a predetermined amount of liquid crystal 14 is dropped onto plural places of the surface of the TFT substrate 2, and the sealing agent 16 is coated on the outer peripheral part of the CF substrate 4. Next, both the substrates 2 and 4 are aligned and bonded to each other in vacuum by using a substrate bonding apparatus, and a bonded substrate is fabricated. Next, when the bonded substrate is returned into the air, the liquid crystal 14 in the bonded substrate is diffused by the atmospheric pressure. Incidentally, the diffusion sheet 74 may be bonded at other timings before a step of curing the sealing agent 16 by irradiation of UV light, for example, it may be bonded before CFs are formed on the glass substrate 7 or after the bonded substrate is fabricated.

Next, the UV light is irradiated to the sealing agent 16 by using a UV light irradiation apparatus. As shown in FIG. 10, light beams i and j incident on the glass substrate 7 in a direction relatively close to the vertical direction relative to the substrate surface are incident on the diffusion sheet 74. The light beam i is diffused by the diffusion sheet 74, and a part thereof is transmitted as a light beam k. The light beam j is diffused by the diffusion sheet 74, and a part thereof is transmitted as a light beam 1. The light path of the light beam k is changed toward the side of the sealing agent 16 with respect to the light beam i, and the light path of the light beam 1 is changed toward the side of the sealing agent 16 with respect to the light beam j. The light beams k and 1 have light paths changed toward directions closer to the direction parallel to the substrate surface.

The light beams k and 1 are transmitted through the glass substrate 7 and are incident on the glass substrate 6. The light beams k and 1 are reflected at the rear surface (panel outside surface) of the glass substrate 6 or the surface of an irradiation stage (not shown in FIG. 10) being in contact with the rear surface of the glass substrate 6, and are incident on the sealing agent 16. Thereafter, the light beams k and 1 are further reflected at the surfaces of the metal wiring lines 10, 11 and 12, and are also incident on regions of the sealing agent 16 where the metal wiring lines 10, 11 and 12 are formed to overlap. By this, the UV light is irradiated on all the regions of the sealing agent 16, and the sealing agent 16 is quickly cured. Thereafter, part of the substrates 2 and 4 outside of the sealing agent 16 may be cut off and discarded. The liquid crystal display device according to this modified example is completed through the above processes.

In this example, although the diffusion sheet 74 as the light path changing part is bonded to the panel outside surface of the CF substrate 4, the diffusion sheet 74 may be bonded to the panel outside surface of the TFT substrate 2. Besides, in this example, although the diffusion sheet 74 is bonded as an optical film, another optical film, such as a prism sheet, capable of changing a light path of at least part of light toward the side of the sealing agent 16 may be bonded. Alternatively, instead of the light path changing treatment for forming the light path changing part, an incident light increasing treatment may be performed in which an optical film such as an antireflection (AR) film is bonded to the panel outside surface of the CF substrate 4 as an incident light increasing part for increasing the luminous energy of light incident on the glass substrate 7 by increasing the transmissivity of incident light. Further, plural such optical films may be stacked and bonded. Besides, the optical film may have a function as a polarizing plate.

In this example, although the optical film such as the diffusion sheet 74 is bonded to substantially the whole surface including the display region, it may be bonded to only a region outside of the BM 8. In this case, it becomes necessary to provide a step of bonding another optical film to the display region and its periphery after the bonded substrate is fabricated.

According to this modified example, since it becomes unnecessary to provide a step of forming the irregularities 72 on the panel outside surface of the TFT substrate 2 or the CF substrate 4, the manufacturing process of the liquid crystal display device can be simplified.

In the invention, various modifications can be made in addition to the above embodiments.

For example, in the above-mentioned embodiments, although the metal wiring lines are formed in parallel with a coating direction of the sealing agent, the invention is not limited to this. The metal wiring lines can also be formed not in parallel with the coating direction of the sealing agent. Besides, while the metal wiring lines are crossed on the substrate, the maximum widths of the metal wiring lines are all 0.1 mm or less. Therefore, the maximum widths of crossed portion of the wiring lines are also all 0.1 mm or less.

For example, in the first, second to fifth embodiments, although the liquid crystal display device is cited as an example in which the liquid crystal is injected using the drop injection method, the invention is not limited to this, but can be applied to a liquid crystal display device in which the liquid crystal is injected using a vacuum injection method.

Besides, in the above embodiments, although the UV light is irradiated from the side of the CF substrate 4, the invention is not limited to this. For example, in the case of a CF-on-TFT structure in which a color filter is formed on the side of the TFT substrate 2, the UV light can also be irradiated from the side of the TFT substrate 2. Besides, when a mask for shading the display region is used, the UV light may be irradiated from the side of the TFT substrate 2 on which CFs are not formed.

Besides, in the above embodiments, although the transmission type liquid crystal display device has been exemplified, the invention is not limited to this, but can also be applied to another liquid crystal display device such as a reflection type or a semi-transmission type.

As described above, according to the invention, it is possible to realize the substrate for the liquid crystal display device in which the manufacturing process can be simplified and the frame part can be narrowed, the liquid crystal display device provided with the same, the manufacturing method of the same, and the manufacturing apparatus of the same.

What is claimed is:

1. A liquid crystal display device, comprising:
two substrates disposed to be opposite to each other;
a liquid crystal sealed between the two substrates;
a light shielding film formed on an outer peripheral part of one of the substrates to intercept light;
a display region defined by the light shielding film;
a metal layer formed on an outer peripheral part of the other substrate at a side of the liquid crystal and having a width of 0.1 mm or less; and
a photo-curing sealing agent coated on the outer peripheral part to overlap with the light shielding film when viewed in a vertical direction relative to a substrate surface and provided with a light irradiated region overlapping with the metal layer.

2. A liquid crystal display device according to claim 1, wherein the other substrate includes a light shielding layer for intercepting light within a region from an end part of the display region to an end part of the sealing agent at a side of the display region.

3. A liquid crystal display device according to claim 2, wherein the light shielding layer includes an overlap region having an overlap width of 0.1 mm or less and overlapping with the sealing agent when viewed in a vertical direction relative to the substrate surface.

4. A liquid crystal display device according to claim 1, wherein at least one of the one substrate and the other substrate includes, on a surface outside the light shielding film, a light path changing part for changing a light path of incident light toward the sealing agent.

5. A liquid crystal display device according to claim 4, wherein the light path changing part includes irregularities formed before the sealing agent is irradiated with light.

6. A liquid crystal display device according to claim 4, wherein the light path changing part includes an optical film bonded before the sealing agent is irradiated with light.

7. A liquid crystal display device according to claim 6, wherein the optical film includes a diffusion sheet.

8. A liquid crystal display device according to claim 6, wherein the optical film includes a prism sheet.

9. A liquid crystal display device according to claim 1, wherein the one substrate includes, on a surface outside the light shielding film, an incident light increasing part for increasing incident light.

10. A liquid crystal display device according to claim 9, the incident light increasing part includes an optical film bonded before the sealing agent is irradiated with light.

11. A liquid crystal display device according to claim 10, wherein the optical film includes an antireflection film.

12. A substrate for a liquid crystal display device, comprising:
a light shielding film formed on a transparent substrate;
a sealing agent coating region disposed on the light shielding film where a sealing agent is coated when the transparent substrate is bonded to an opposite substrate disposed to be opposite;
a temporary fastening sealing agent coating region where a temporary fastening sealing agent is coated when the transparent substrate is bonded to the opposite substrate disposed to be opposite; and
a light shielding layer disposed around the temporary fastening sealing agent coating region and for intercepting light so that the light irradiated to the temporary fastening sealing agent is not irradiated to the sealing agent.

13. A liquid crystal display device comprising two substrates disposed to be opposite to each other, and a liquid crystal sealed between the two substrates,
wherein a substrate for a liquid crystal display device according to claim 12 is used for one of the two substrates.

14. A manufacturing apparatus of a liquid crystal display device, comprising:
an irradiation stage for mounting a bonded substrate including two substrates bonded through a photo-curing sealing agent;
a light source for irradiating the bonded substrate with light to cure the sealing agent; and
a reflection mirror for reflecting the light so that the light is incident on a surface of the bonded substrate in an inclined direction.

15. A manufacturing apparatus of a liquid crystal display device, comprising:
an irradiation stage having an irradiation surface on which a bonded substrate including two substrates bonded through a photo-curing sealing agent is mounted, and provided with one of a metal layer having a high optical reflectance, a white plate and a scattering sheet on the irradiation surface; and
a light source for irradiating the bonded substrate with light to cure the sealing agent.

16. A manufacturing method of a liquid crystal display device, comprising:
a first step of coating a photo-curing sealing agent on an outer peripheral part of one of a pair of substrates;
a second step of bonding the pair of substrates through the sealing agent to fabricate a bonded substrate; and
a third step of curing the sealing agent by irradiation of light,
wherein the manufacturing method of the liquid crystal display device further comprises, before the third step, a step of performing, at least at one of a front surface and a rear surface of the bonded substrate and at a region outside the sealing agent coated region, a light path changing treatment for changing a light path of light incident on the substrate toward the sealing agent or an incident light increasing treatment for increasing light incident on the substrate.
